(19) United States
(12) Patent Application Publication
(10) Pub. No.: US 2017/0176175 A1
(43) Pub. Date: Jun. 22, 2017

(54) AUTOMATED TIRE BUFFING IDENTIFICATION APPARATUS AND METHOD

(71) Applicant: Bridgestone Bandag, LLC, Muscatine, IA (US)

(72) Inventor: John S. Lindsay, Muscatine, IA (US)

(21) Appl. No.: 14/972,247

(22) Filed: Dec. 17, 2015

(51) Int. Cl. G01B 11/14; B29D 30/54; G01B 11/24

(52) U.S. Cl. CPC G01B 11/14; G01B 11/24; B29D 30/54; B29D 2030/541; B29D 2030/546

(57) ABSTRACT

Systems and methods of identifying and buffing tire casings are provided. A tire buffing machine includes an expandable rim, a buffer, a measurement sensor configured to generate measurement data, and a controller. The controller maintains a database of a plurality of casing profiles, where each casing profile includes known casing measurements and corresponding buffing parameters. The controller receives measurement data from the measurement sensor, identifies the casing mounted onto the expandable rim, and operates the buffer to buff the casing in accordance with buffing parameters in the matching casing profile.

### CROSS REFERENCE TO RELATED APPLICATIONS

The application has been filed concurrently with the application of James Kendall titled “Self Correcting Tire Buffing Apparatus and Method,” which is herein incorporated by reference in full.

### TECHNICAL FIELD

The present invention relates generally to devices and methods for retreading tires, and more particularly to devices and methods for automated tire buffing and identification of a tire casing to remove worn tread.

### BACKGROUND

A tire casing selected for retreading may be buffed to remove excess rubber to provide a substantially evenly textured crown for receiving a tread strip or other tread and to provide a predetermined tire casing profile. Tire casings may include a belt package (a package of steel belts or cables) underlying the road-engaging surface (e.g., the original tread) of the tire. The casing may be buffed to leave only a predetermined thickness, e.g., 3/32 of an inch, of material remaining over the top belt. The shoulder of the casing may be also buffed (trimmed) to eliminate or reduce voids or patterns in the shoulder created by the original tread, and to provide, typically, a relatively straight profile between the casing side walls and the crown.

After being buffed, the tire casing may then be examined for injuries, which are skived and filled with a repair gum. After completion of the skiving process, the buffed surface may be sprayed with tire cement that provides a tacky surface for application of a suitable layer of bonding material, such as cushion gum placed over the crown. In some retreading operations, the spray cement can be omitted.

A cured tread strip, which may be of a width corresponding to the width of the crown of the casing, may be cut to the length corresponding to the casing circumference and disposed over the casing crown. Continuous replacement treads in the shape of a ring (i.e., ring treads) have also been used to retread the buffed casing. Thereafter, the assembly may be placed within a curing chamber and subjected to elevated pressure and temperature for a predetermined period of time. The combination of exposure to elevated pressure and temperature for a duration of time binds the cushion gum to both the tire casing and the new tire tread.

The surface of the tire casing may be buffed about the shoulder areas of the tire to ensure that the tread layer width is approximately the same as the buffed surface of the casing. If the shoulder areas are not sufficiently buffed and trimmed, the tread edges may come loose and/or the cushion gum extending beyond the tread edges will not bond to the casing shoulder. Such problems can reduce the longevity of the retreaded tire and adversely impact the appearance of the retreaded tire.

The shape and contour of the tire casing being buffed may be important to determining the necessary buffing operations that need to be performed. Some buffing machines are manually operated such that the final product of buffing is dependent on the skill of the operator. In other situations, data pertinent to buffing is stored in the buffing machine and such data may be extracted by the operator for proper buffing to proceed. Tire casings typically include sidewall markings, which may indicate various characteristics regarding a given tire casing. Tire casings are variable in size and shape such that errors and inefficiencies occur through improper identification of the properties of the tire casing.

Thus, there exists a need for a tire buffing machine which is easy to use and which improves tire buffing efficiency.

### SUMMARY

A tire buffing machine may include an expandable rim configured to accommodate a plurality of casing sizes thereon, a buffer configured to buff a casing mounted onto the expandable rim, a measurement sensor configured to generate measurement data for a casing mounted onto the expandable rim, and a controller. The controller may be configured to maintain a database containing a plurality of casing profiles, each casing profile including known casing measurements and corresponding buffing parameters. The controller may be further configured to receive measurement data of a casing mounted onto the expandable rim from the measurement sensor. The controller may be configured to identify the casing mounted onto the expandable rim, including comparing the measurement data with known casing measurements in the database to find a matching casing profile. The buffer may be further configured to buff the casing in accordance with buffing parameters in the matching casing profile.

In some instances, a controller may enable a tire buffing machine to measure, identify, and buff a plurality of casings, the controller including instructions stored on non-transient data media causing the controller to perform operations. The operations may include maintaining a database containing a plurality of casing profiles, each casing profile including known casing measurements and corresponding buffing parameters. The operations may further include receiving measurement data of a casing mounted onto a rim from a measurement sensor. The operations may include identifying the casing mounted onto the rim, including comparing the measurement data with known casing measurements in the database to find a matching casing profile. The operations may further include operating a buffer to buff the casing in accordance with buffing parameters in the matching casing profile.

In some embodiments, a method may be provided identifying and buffing a casing mounted onto a rim. The method may include maintaining, in a database, a plurality of casing profiles, each casing profile including known casing measurements and corresponding buffing parameters. The method may further include generating, by a measurement sensor, measurement data of the casing mounted onto the rim. The method may include identifying, by a controller, the casing mounted onto the rim, including comparing the measurement data with known casing measurements in the database to find a matching casing profile. The method may further include operating a buffer to buff the casing in accordance with buffing parameters in the matching casing profile.

The features of the present invention will become apparent to one of ordinary skill in the art upon reading the detailed description and claims, in conjunction with the accompanying drawings, provided herein. The scope of this disclosure includes various changes and modifications to the embodiments without departing from the spirit and scope of the present invention.

### BRIEF DESCRIPTION OF THE DRAWINGS

FIG. 1 is a top plan view of a tire buffer with a tire casing mounted to a hub assembly and sensing apparatus in a home position.

FIG. 2 is a top plan view of a tire buffer of FIG. 1 with a tire casing mounted to a hub assembly and sensing apparatus in a measuring position.

FIG. 3 is a rear elevational view of the rasp pedestal of FIG. 1 with sensing apparatus in a retracted position.

FIG. 4 is a rear elevational view of the rasp pedestal of FIG. 1 with sensing apparatus in a deployed position.

FIG. 5 is a schematic view of the sensing apparatus deployed around a tire casing.

FIG. 6 is a schematic view of the sensing apparatus deployed around a tire casing with one of its arms in movement.

FIG. 7 is a schematic view of the sensing apparatus deployed around a tire casing with one of its arms in movement.

### DETAILED DESCRIPTION

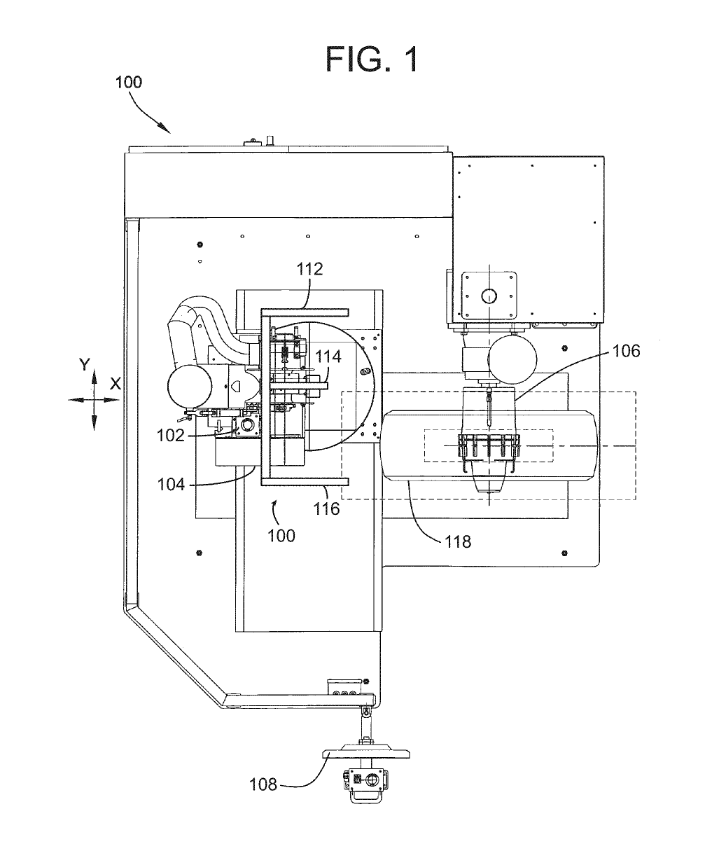

An illustrative tire buffing apparatus 100 is shown in FIG. 1. The apparatus 100 includes a rasp pedestal 102, a pedestal movement assembly 104, a tire hub assembly 106, a controller 108, and a laser array 110.

The rasp pedestal 102 is configured to remove material from a tire casing to provide a predetermined, buffed tire casing profile with a desired surface texture. In various embodiments, the rasp pedestal 102 may include a rasp head housing a rasp or a rotary blade configured to strip material from outer surfaces of a casing mounted on the tire hub assembly 106. The rasp head may further include a texturing brush, which may be applied to casing surfaces to impart a specified texture to crown and shoulder portions of the casing to facilitate a subsequent retreading process.

The rasp pedestal 102 may be mounted to the pedestal movement assembly 104, which provides a range of motion for the rasp pedestal 102. The pedestal movement assembly 104 may be configured to allow the rasp pedestal 102 to travel along an X and a Y axis to approach and position the rasp or brush with respect to a mounted casing. The pedestal movement assembly 104 may further allow the rasp pedestal 102 to rotate about a Z axis (i.e., extending out of FIG. 1, perpendicular to the X and Y axes) to allow the rasp head to engage the mounted casing at specified angles, for example to buff shoulder portions of the casing. In one arrangement, the pedestal movement assembly 104 includes respective sets of rails and bearings corresponding to the X and Y axes, and a pivot hinge disposed at a base portion of the rasp pedestal 102 to enable Z axis rotation.

The tire hub assembly 106 is configured to provide a mount for a tire casing 118 during an identification and buffing process. In some embodiments, the tire hub assembly 106 is configured to engage a center aperture in the tire casing 118 (i.e., similar to a rim engaging the tire casing), orient the tire casing 118 on a center axis (i.e., a rotational axis of the tire casing), and inflate the tire casing 118. For example, in one embodiment, the tire hub assembly 106 includes an expandable tire chuck (i.e., an expandable rim) having a plurality of radial pistons (e.g., pneumatically or hydraulically actuated). The tire chuck may be disposed in a contracted configuration during an initial casing mounting process, and may subsequently expand (i.e., via the plurality of radial pistons) to engage a center aperture (e.g., defined by a casing bead) of the tire casing 118. The tire chuck may be further configured to expand in a manner sufficient to orient the tire casing 118 on a center axis. In addition, the tire hub assembly 106 may include an airflow line in fluid communication with an interior portion of the tire casing 118, thereby allowing the tire casing 118 to be inflated. The tire hub assembly 106 may further be operatively coupled to a motor with a rotational output at the tire chuck, and as such, the tire hub assembly 106 may rotate the tire casing 118 during a buffing process.

The laser array 110 is an example embodiment of a casing measurement and identification device. The laser array 110 includes a plurality of laser-based distance sensors mounted on the rasp pedestal 102 and is configured to receive a plurality of distance measurements with respect to the tire casing 118 mounted on the tire hub assembly 106. In other embodiments, various other types of sensors may be used as the casing measurement and identification device (e.g., infrared sensors, optical sensors, etc.). In the embodiment shown, the laser array 110 includes a first arm 112, a second arm 114, and a third arm 116 extending from the rasp pedestal 102 toward the tire hub assembly 106. In one such embodiment, each of the arms of the laser array 101 are disposed in parallel and evenly spaced from each other, with the second arm 114 disposed between the first arm 112 and the third arm 116. In some embodiments, each of the arms of the laser array 110 may be separately mounted on the rasp pedestal 102 or other structure, and may also be independently operated. The first arm 112 and the third arm 116 may be sufficiently spaced apart to straddle the tire casing 118 mounted on the tire hub assembly 106. In addition, the first arm 112 and the third arm 116 may extend a sufficient distance from the rasp pedestal 102 to reach past the sidewalls of the tire casing 118 (i.e., when the rasp pedestal 102 is disposed adjacent to the tire hub assembly 106). The second arm 114 may extend a shorter length than the first arm 112 and the third arm 116, and the second arm 114 may be configured to direct a laser and corresponding sensor toward a crown portion of the tire casing 118.

The controller 108 is communicatively coupled to the other components of the apparatus 100, and is configured to identify and buff the tire casing 118 based on the set of measurement data provided by the laser array 110. In some embodiments, the controller 108 is configured to mount, orient, and inflate the casing 118 on the tire hub assembly 106. The controller 108 may then cause the pedestal movement assembly 104 to move the rasp pedestal 102 toward the tire casing 118. In some embodiments, the operations discussed with respect to the controller 108 are performed by a plurality of separate controllers acting as a single controller, or a plurality of computing components of the same controller that operate the buffer and identify the tire casing 118.

As the rasp pedestal 102 moves towards the tire casing 118, the controller 108 cooperates with the laser array 110 to generate a set of measurement data. In some arrangements, the set of measurement data includes a plurality of distance measurements taken from each of the laser-based distance sensors disposed at respective ends of the first arm 112 (e.g., measurements along a first casing sidewall), second arm 114 (e.g., measurements along a second casing sidewall), and third arm 116 (e.g., measurements from the rasp pedestal 102 to the crown of the tire casing 118). In some such arrangements, the set of measurement data includes a plurality of measurements from each of the arms of the laser array 110 (e.g., 16 measurements per arm, 32 measurements per arm, 64 measurements per arm, etc.). The controller 108 may be configured to use the set of measurement data to determine a cross-sectional casing profile from the crown to the bead of the tire casing 118, which may be used to identify the tire casing 118.

The tire casing 118 measurements that the controller 108 may derive from the set of measurement data include, for example, a tire radius (i.e., distance from the center axis to the outer crown edge), a rim radius (i.e., distance from center axis to a casing bead), circumference, and aspect ratio. The tire radius may be determined, for example, through inputs from the pedestal movement assembly 104 and the second arm 114. The location of the center axis of the tire casing 118 relative to the rasp pedestal 102 may be stored as a known value at the controller 108 (e.g., the center point of the tire chuck on the tire hub assembly 106). The position of the rasp pedestal 102 on the pedestal movement assembly 104 along the X axis may be received at the controller 108. In addition, distance measurements from the second arm 114 (i.e., positioned at the rasp pedestal 102) to the outer crown surface of the tire casing 118 may be received as the controller 108 as well. The controller 108 may take the difference between the position of the center axis of the tire casing 118 and the distance of the second arm 114 to the outer crown surface to determine the tire radius. The rim radius may be determined in a similar manner, incorporating data from the first arm 112 and/or the third arm 116 instead of the second arm 114. For example, the controller 108 may be configured to determine the distance of the bead of the tire casing 118 from the rasp pedestal 102 using measurement data provided by the first arm 112 and/or the third arm 116. The difference between the distance from the rasp pedestal 102 to the center axis and the distance from the rasp pedestal 102 to the bead yields the rim radius.

As another example, the controller 108 may be able to determine the rim radius of the tire casing 118 via the expandable tire chuck of the tire hub assembly 106. In one embodiment, the diameter of the tire chuck in the contracted configuration may be stored as a known value at the controller 108. The controller 108 may further be configured to cooperate with the tire hub assembly 106 to measure the amount of radial chuck expansion needed to engage the bead of the tire casing 118. The amount of radial chuck expansion may then be used to determine the rim radius of the tire casing 118 (i.e., dividing the tire chuck diameter upon engaging the tire casing 118 by two to yield rim radius). The controller 108 may take the sum of the rim radius and the distance from the bead to the crown (i.e., the height) of the tire casing 118 (e.g., as provided by the laser array 110) to determine the tire radius as well. The tire radius may be used to determine the outer circumference of the tire casing 118 as well.

The controller 108 may determine the section width of the tire casing 118, which may be used in addition to the height of the tire casing 118 to determine an aspect ratio. The section width may be determined from measurement data provided by the first arm 112 and the third arm 116 (i.e., via the shortest measurements taken by each respective arm, indicating the widest point of each side of the tire casing 118). In turn, the height may also be determined from measurement data provided by the first arm 112 and the third arm 116 (i.e., distance from the crown to the bead). In some arrangements, the controller 108 may be configured to correct the height determination to account for sidewall curvature (e.g., using a first measurement point where the crown is detected and the last measurement point where the bead is detected). The controller 108 may then determine an aspect ratio using the section width and the section height.

In some arrangements, the controller 108 may be configured to account for irregularities on the surface of the tire casing 118. For example, many tire manufacturers include raised characters and symbols on tire casing sidewalls to indicate brand, model, and specifications. As another example, abrasions and other types of wear or abuse related damage may affect the outer dimensions of the tire casing 118. As such, the controller 108 may be configured to detect and ignore surface irregularities on the tire casing 118 during the measurement and identification process (e.g., identifying and discarding sharply different measurement points, indicating a raised letter).

Upon determining a predetermined set of measurement types for the tire casing 118, the controller 108 may be configured to identify the specifications for the tire casing (e.g., rim radius, section width, and aspect ratio) and corresponding buffing parameters. In some embodiments, the controller 108 is further able to determine specific makes and models of the tire casing 118 based on the set of measurements. The controller 108 may be communicatively coupled to local or networked storage devices housing one or more databases of casing profiles corresponding to casing specifications, measurements, and buffing parameters. As such, the controller 108 may be able to use the set of measurement data to identify the tire casing 118 and appropriate buffing parameters via the one or more databases.

In some arrangements, the controller 108 is configured to identify a matching casing profile in the database if the set of measurement types is within a predetermined tolerance of variance from a given profile (e.g., similar radius and aspect ratio within a percentage variance of known values). The controller 108 may retrieve appropriate buffing parameters and actuate the buffing pedestal 102 to buff the tire casing 118 accordingly. If the controller 108 is unable to identify a matching casing profile, the controller 108 may be configured to provide an operator with an alert (e.g., on a visual display, an audible alert, etc.) and pause the buffing process. In some arrangements, the controller 108 may be operatively coupled to an input/output assembly (e.g., a touchscreen, a keyboard and monitor, etc.), whereby an operator may manually enter buffing parameters, parameter adjustments, etc.

In operation, the rasp pedestal 102 may initially be disposed away from the tire hub assembly 106. The tire casing 118 may be mounted to the tire hub assembly 106, which may include expanding a tire chuck to engage the bead of the tire casing 118. The tire hub assembly 106 may then orient the tire casing 118 on a center axis (e.g., by uniformly extending and adjusting a plurality of radially-disposed chuck pistons), and inflate the tire casing 118.

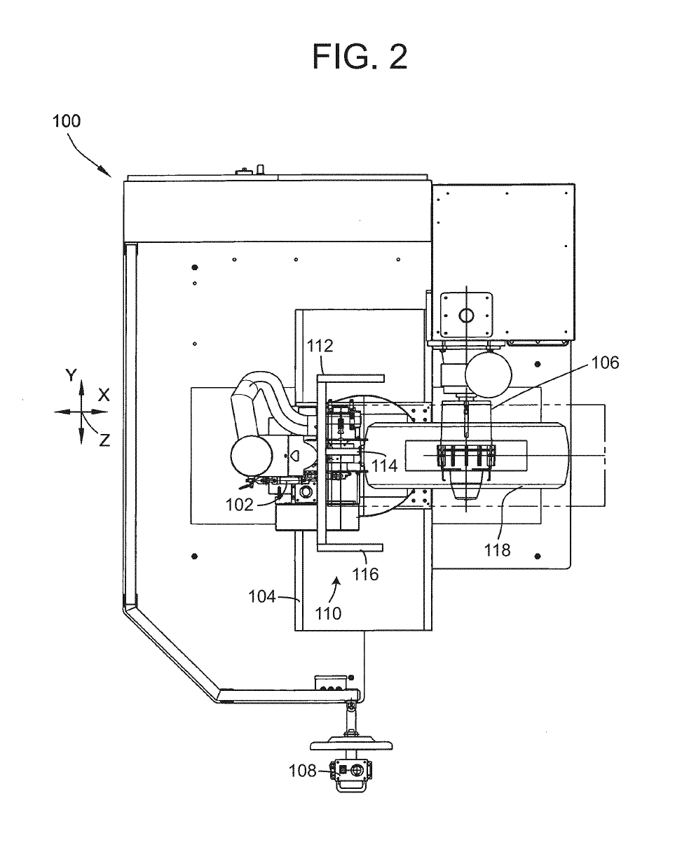

Referring FIG. 2, the pedestal movement assembly 104 may cause the rasp pedestal 102 to approach the tire casing 118. The rasp pedestal 102 approaches the tire casing 118 such that the tire casing 118 is positioned between the first arm 112 and the third arm 116 of the laser array 110. In one embodiment, as soon as lasers disposed on the first arm 112 and the third arm 116 detects the tire casing 118 (e.g., the outer edge of the crown of the tire casing 118 breaks the respective laser paths), the second arm 114 begins measuring the distance of the crown of the tire casing 118 to the rasp pedestal 102. The rasp pedestal 102 continues to move toward the tire casing 118 via the pedestal movement assembly 104 along the X axis until the first arm 112 and/or the third arm 116 extends to or past the bead of the tire casing 118. As the rasp pedestal 102 progresses, the laser array 110 sends a set of measurement data to the controller 108 (e.g., 64 measurement points).

Once the controller 108 receives the set of measurement data, the controller 108 determines a plurality of measurements and specifications for the tire casing 118, including in some embodiments, a make and model of the tire casing 118. Using the measurements and specifications, the controller 108 receives a set of buffing parameters from an associated buffing database. The controller 108 then causes the rasp pedestal 102 to buff the tire casing 118 in accordance with the set of buffing parameters.

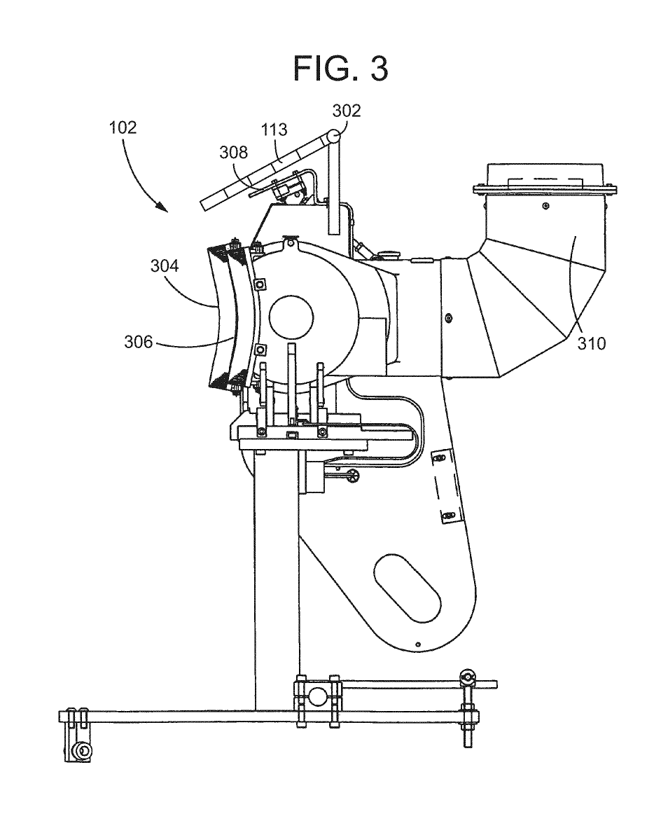

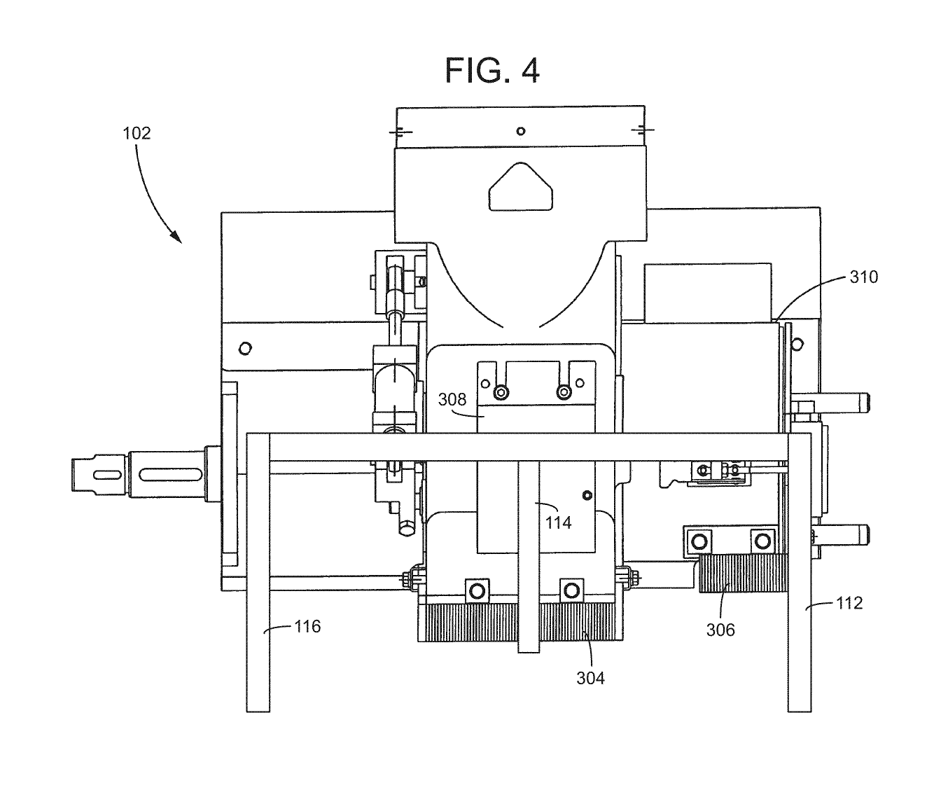

Referring now to FIGS. 3 and 4, the rasp pedestal 102 includes additional features configured to monitor and correct the operation of the buffing process. In some embodiments, some or all of the arms of the laser array 110 include a hinge 302. The hinge 302 may be actuated by the controller 108 to lift an associated arm up (e.g., toward the Z axis) and away from the tire casing 118 during the buffing process. For example, after the controller 108 identifies the tire casing 118, the controller 108 may lift the first arm 112 and the third arm 116 up and away from the tire casing 118 to allow the rasp pedestal to rotate adjacent to the tire casing 118 about the Z axis. Further, in some embodiments, the arms of the laser array 110 may be configured to be telescoping. In such embodiments, the controller 108 may be configured to extend individual arms of the laser array 110 for casing measurement and identification, and retract individual arms during a subsequent buffing process.

In the arrangement shown, the rasp pedestal 102 includes a rasp housing 304 and a brush housing 306. The rasp housing 304 and the brush housing 306 each include an opening to allow a respective rasp and a brush to engage a tire casing mounted to the tire hub assembly. The openings may be contoured to complement the circumference of a tire casing being buffed. In some embodiments, each opening includes a perimeter with a bristle strip projecting therefrom and toward the tire hub assembly. The bristle strips can conformingly engage a tire casing mounted to the tire hub assembly during the buffing sequence to prevent tire casing material removed by the rasp or the brush from exiting the respective opening. The bristle strips can also facilitate a debris collection system by providing a seal with the tire casing to increase the suction power of the debris collection system.

The rasp pedestal 102 can include a belt sensor 308, which can be provided as a buffering feedback and correction device. The belt sensor 308 may be mounted to the rasp head assembly (e.g., proximal to the rasp housing 304). The belt sensor 308 can be electrically connected to the controller 108 by way of a line. The belt sensor 308 is positioned to measure the distance to one or more belts disposed in the tire casing 118 mounted to the tire hub assembly 106. In one embodiment, the belt sensor 308 emits an electromagnetic beam directed toward the tire casing 118 during the buffing process. The belt sensor 308 receives a reflection of the electromagnetic wave from the one or more belts disposed in the tire casing 118, which the controller 108 may use to measure the distance of the rasp to the one or more belts. In some arrangements, the belt sensor 308 does not measure belt distances until a threshold amount of tread is buffed from the tire casing 118. In addition, in some arrangements, the belt sensor 308 operates in conjunction with one or more adjacent distance sensors (e.g., optical, laser, etc.) directed towards the crown surface of the tire casing 118. In some such arrangements, a first distance sensor is disposed towards a pre-buff location on the crown surface, and a second distance sensor is disposed towards a post-buff location on the crown surface. In operation, the controller 108 may use inputs from the first and second distance sensors to determine an amount of casing material removed by the buffer (e.g., the difference between the distance data generated by the first and second distance sensors). Such an arrangement may be provided by the application of James Kendall, entitled “Self Correcting Tire Buffing Apparatus and Method,” hereby incorporated in full.

The rasp pedestal 102 may be coupled to a debris collection system including a debris duct 310 in fluid receiving communication with the rasp housing 304 and the brush housing 306. The debris duct 310 may also be operatively coupled to a suction source (not shown) configured to lower the air pressure within the debris duct 310 to effect a suction through the rasp housing 304 and the brush housing 306. In addition, one or more flow sensors configured to measure particulate matter in airflows may be disposed in fluid communication with airflows through the debris duct 310. The one or more flow sensors may be communicatively coupled to the controller 108, which may therefore determine the amount of tire materials removed by the rasp or brush during the buffing process.

In operation, after the controller 108 identifies the tire casing 118, the controller 108 may begin buffing the tire casing 118 according to an appropriate set of buffing parameters. In some embodiments, prior to initiating the buffing process, the controller 108 may cause some or all of the arms of the laser array 110 to retract or pivot upwards towards the Z axis to allow the rasp pedestal 102 to freely rotate about the tire casing 118.

Due to variances in casing materials, variances in casing dimensions across brands, or even variances in casing dimensions within brands, unchecked applications of standard buffing parameters may result in under or overbuffing of the casing (e.g., removing too much casing material and exposing one or more belts, removing too little casing material, etc.). As such, in some embodiments, the controller 108 uses inputs from the belt sensor 308 to determine the depth of the belts within the tire casing 118 along with inputs from sensors in the debris duct 310 to monitor the amount of material removed from the tire casing 118 during the buffing process. In addition, the controller 108 can be associated with a current sensor which senses the current draw of a rasp drive motor for rotating the rasp head and the texturing device. The rasp drive motor can have a predetermined full-load capacity at which its current draw is a particular value and at which the motor can remove material from the tire casing 118 at an efficient rate while preventing damage to the motor or other components of the tire buffer. The value of the predetermined target current draw can be based upon such considerations as the capabilities of the motor driving the cutter, the maximum depth of cut for the selected cutter, the maximum traverse speed the buffer is capable of generating, and the wear of the cutter itself. The controller 108 can compare the actual current draw of the rasp drive motor to the calculated target current draw and determined whether the actual current draw is equal to the target current draw. If the actual and target current draws are different, the controller 108 can move the rasp pedestal 102 at different rates of speed by selectively controlling the rasp moving assembly to adjust the actual current draw such that it moves toward the target current draw. The traverse rate of speed of the rasp pedestal 102 can be increased to increase the actual current draw of the motor and decreased to decrease the actual current draw of the motor. The depth of cut and the rate of rotation of the tire casing can remain constant during the buffing operation.

For example, the controller 108 may determine that the change in belt depth after a first buffing pass about the outer circumference of the crown exceeds an expected parameter (e.g., where the belts are disposed at an unexpectedly shallow depth). In response, the controller 108 may change a target circumference for the tire buffer to prevent the rasp from hitting the belts on the tire casing 118. The controller 108 may continue to receive measurements from the belt sensor 308 and the material sensor in the debris duct 310 and make corresponding adjustments throughout the buffing process.

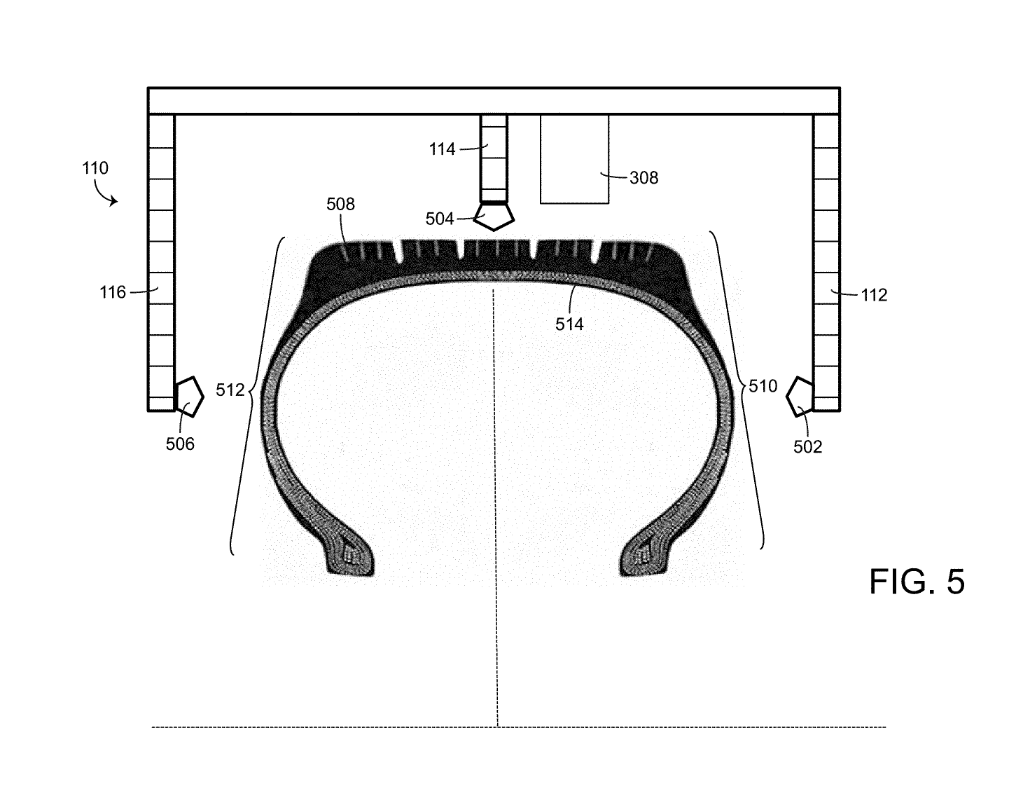

Referring to FIGS. 5-7, the laser array 110 may be configured in various ways to generate the set of measurement data used by the controller 108 to identify the tire casing 118. In FIG. 5, the first arm 112, the second arm 114, and the third arm 116 of the laser array 110 are shown respectively with a first laser 502, a second laser 504, and a third laser 506 disposed on corresponding distal ends. The first laser 502 of the first arm 112 is shown horizontally opposed to the third laser 506 of the third arm 116, and sufficiently spaced apart to accommodate a section width of the tire casing 508 between them. As such, the first laser 502 may be configured to generate measurement data corresponding to a first sidewall 510 and the third laser 506 may be configured to generate measurement data corresponding to a second sidewall 512 as the laser array 110 approaches the tire casing 508. The second laser 504 of the second arm 114 is centrally disposed between the first arm 112 and the third arm 116, and directed toward a middle portion of the crown of the tire casing 508. As such, the second laser 504 may be configured to generate measurement data corresponding to the distance of the laser array 110 (e.g., and the rasp pedestal 102) from the outermost edge of the tire casing 508. The belt sensor 308 may be positioned adjacent to the second arm 114 and directed toward the tire casing 508 as well. The belt sensor 308 may therefore detect and measure the depth of a plurality of belts 514 disposed at the crown portion of the tire casing 508.

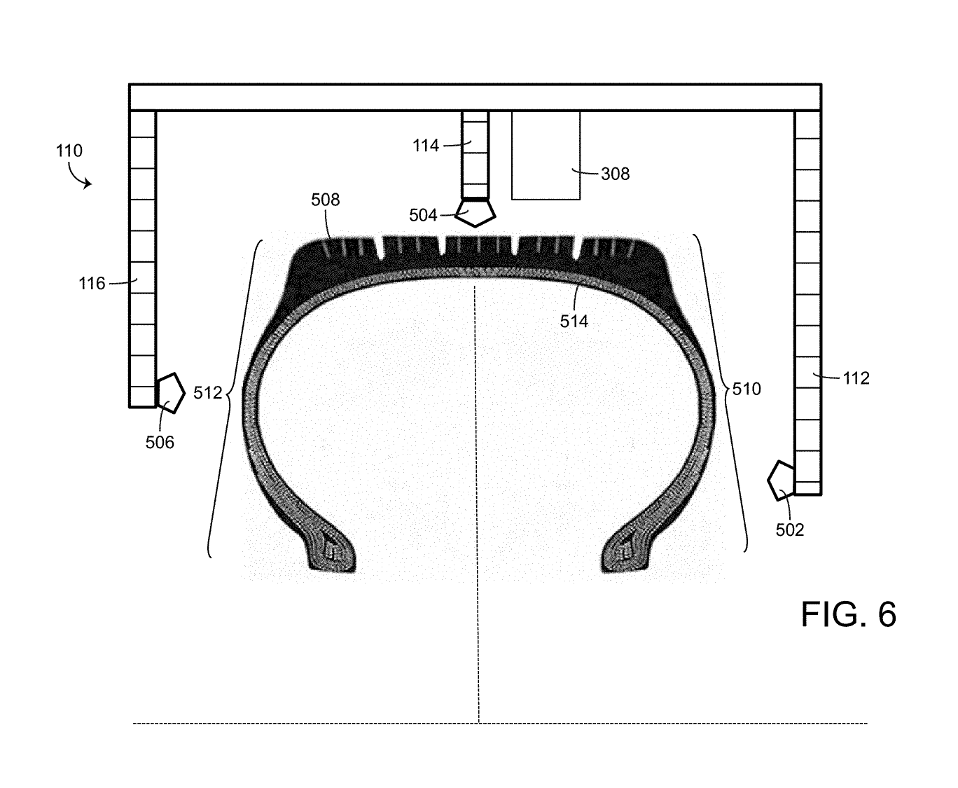

With respect to FIG. 6, the laser array 110 and the belt sensor 308 may be positioned in a substantially similar manner as described for FIG. 5, however the first arm 112 is shown extending farther than the third arm 116. As demonstrated in FIG. 5, in some arrangements, some or all of the arms of the laser array 110 are capable of telescopically extending and retracting. The arms of the laser array 110 may therefore, in some arrangements, independently extend and retract to generate measurement data corresponding to the tire casing 508.

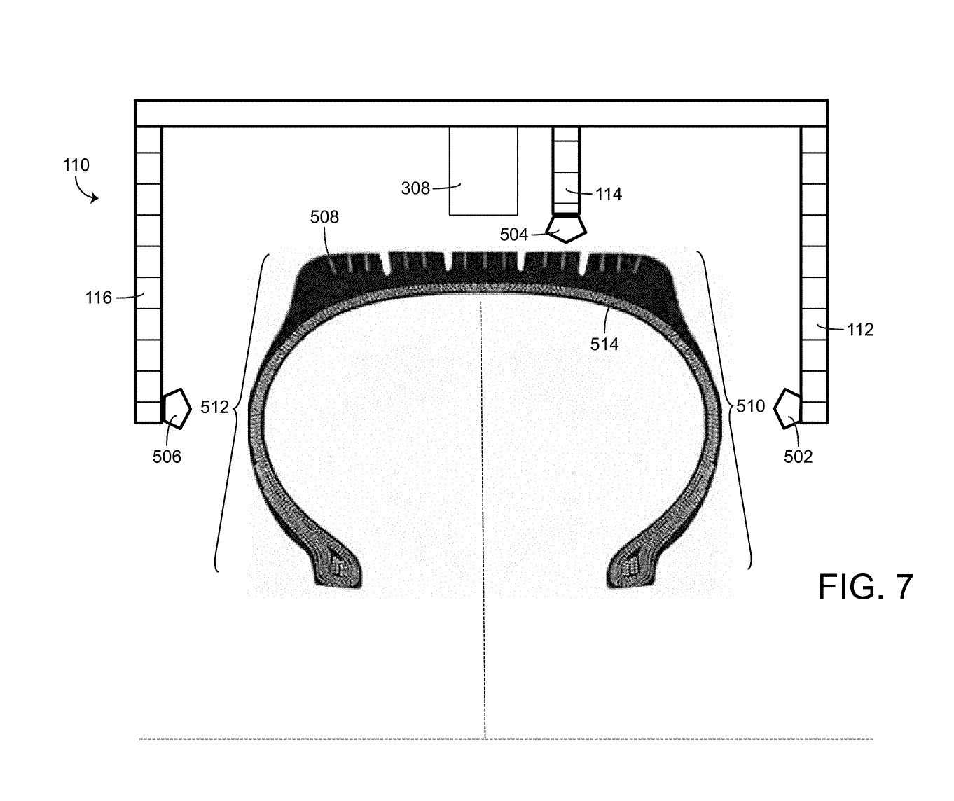

Finally, with respect to FIG. 7, in some arrangements, the second arm 114 and the second laser 504 are disposed off-center between the first arm 112 and the third arm 116. In such arrangements, the second laser 504 may be directed toward and measure distances to an off-center portion of the crown of the tire casing 508. In operation, over- or under-inflation of a tire may give rise to uneven tread wear after a prolonged period of use. For example, over-inflation may cause the center circumference of the tire (i.e., the middle of the tread) to radially bulge and incur wear at an accelerated rate relative to lateral portions of the tire tread. In turn, under-inflation may cause the lateral portions of tire tread to experience greater amounts of wear relative to the center circumference of the tire. Positioning the second arm 114 and the second laser 504 at an off-center location on the laser array 110 (e.g., between the center circumference and a lateral edge of the tread) may therefore mitigate the risk of generating misrepresentative measurements of the tread of the tire casing 508.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. The inventors expect skilled artisans to employ such variations as appropriate, and the inventors intend for the invention to be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

1. A tire buffing machine, comprising:
an expandable rim configured to accommodate a plurality of casing sizes thereon;
a buffer configured to buff a casing mounted onto the expandable rim;
a measurement sensor configured to generate measurement data for a casing mounted onto the expandable rim; and
a controller configured to:
maintain a database containing a plurality of casing profiles, each casing profile including known casing measurements and corresponding buffing parameters;
receive measurement data of a casing mounted onto the expandable rim from the measurement sensor; and
identify the casing mounted onto the expandable rim, including comparing the measurement data with known casing measurements in the database to find a matching casing profile,
wherein the buffer is configured to buff the casing in accordance with buffing parameters in the matching casing profile.

2. The tire buffing machine of claim 1, wherein the measurement sensor includes at least one laser-based distance sensor.

3. The tire buffing machine of claim 2, wherein the measurement sensor includes a first laser configured to generate measurement data for a first side of the casing mounted onto the expandable rim, a second laser configured to generate measurement data for a second side of the casing mounted onto the expandable rim, and a third laser configured to generate measurement data for a crown portion of the casing mounted onto the expandable rim.

4. The tire buffing machine of claim 2, wherein the measurement data includes a rim radius, a section width, and an aspect ratio.

5. The tire buffing machine of claim 4, wherein the rim radius is determined from data received from the measurement sensor and the expandable rim.

6. The tire buffing machine of claim 4, wherein the controller is configured to correct irregularities in the measurement data.

7. The tire buffing machine of claim 4, wherein the controller is configured to account for sidewall curvature in identifying the casing mounted onto the expandable rim.

8. The tire buffing machine of claim 4, wherein the controller is configured to identify the casing mounted onto the expandable rim by comparing the measurement data with known casing measurements in the database to find a matching casing profile within a predetermined degree of tolerance.

9. The tire buffing machine of claim 4, wherein the controller is configured to alert a user if no casing profiles within the predetermined degree of tolerance are present in the database.

10. The tire buffing machine of claim 1, further comprising a belt sensor configured to generate belt depth data for the casing mounted onto the expandable rim, wherein the buffer is further configured to adjust operation in response to received belt depth data.

11. The tire buffing machine of claim 10, wherein the buffer is configured to adjust operation in response to received belt depth data after the casing is buffed down to a predetermined level.

12. The tire buffing machine of claim 11, further comprising a material sensor configured to generate removed material data while the buffer is buffing the casing, wherein the buffer receives the removed material data and adjusts operation in response to both received belt depth data and removed material data.

13. A controller enabling a tire buffing machine to measure, identify, and buff a plurality of casings, the controller including instructions stored on non-transient data media causing the controller to perform operations comprising:
maintain a database containing a plurality of casing profiles, each casing profile including known casing measurements and corresponding buffing parameters;
receive measurement data of a casing mounted onto a rim from a measurement sensor;
identify the casing mounted onto the rim, including comparing the measurement data with known casing measurements in the database to find a matching casing profile; and
operate a buffer to buff the casing in accordance with buffing parameters in the matching casing profile.

14. The controller of claim 13, wherein the operations further comprise receive belt depth data from a belt sensor while operating the buffer, and adjust the operation of the buffer in response to received belt depth data.

15. The controller of claim 14, wherein the controller is further configured to adjust the operation of the buffer in response to received belt depth data after the casing is buffed down to a predetermined level.

16. The controller of claim 14, wherein the controller is further configured to receive removed material data from a material sensor and adjust the operation of the buffer in response to both received belt depth data and removed material data.

17. A method of identifying and buffing a casing mounted onto a rim, the method comprising:
maintaining, in a database, a plurality of casing profiles, each casing profile including known casing measurements and corresponding buffing parameters;
generating, by a measurement sensor, measurement data for the casing mounted onto the rim;
identifying, by a controller, the casing mounted onto the rim, including comparing the measurement data with known casing measurements in the database to find a matching casing profile; and
operating a buffer to buff the casing in accordance with buffing parameters in the matching casing profile.

18. The method of claim 17, further comprising:
generating, by a belt sensor, belt depth data while the casing is buffed; and
adjusting operation of the buffer in response to received belt depth data.

19. The method of claim 18, wherein the belt sensor generates belt depth data after the casing is buffed down to a predetermined level.

20. The controller of claim 18, wherein the controller is configured to receive removed material data from a material sensor and adjust the operation of the buffer in response to both received belt depth data and removed material data.
